(19) United States
(12) Patent Application Publication
(10) Pub. No.: US 2022/0297192 A1
(43) Pub. Date: Sep. 22, 2022

(54) ADDITIVE MANUFACTURING APPARATUS

(71) Applicant: Mitsubishi Electric Corporation, Tokyo (JP)

(72) Inventors: Shigeru TAKUSHIMA, Tokyo (JP); Hiroyuki KAWANO, Tokyo (JP); Yoshitsugu SAWA, Tokyo (JP)

(73) Assignee: Mitsubishi Electric Corporation, Tokyo (JP)

(21) Appl. No.: 17/636,372

(22) PCT Filed: Nov. 11, 2019
(86) PCT No.: PCT/JP2019/044147

§ 371 Date: Feb. 18, 2022

(51) Int. Cl. B22F 12/49; B22F 12/90; B22F 12/42; B22F 12/00; B23K 26/342; B23K 26/06; B23K 26/082; B23K 26/70

(52) U.S. Cl. CPC B22F 12/49; B22F 12/90; B22F 12/42; B22F 12/226; B23K 26/342; B23K 26/0643; B23K 26/082; B23K 26/702; B33Y 10/00

(57) ABSTRACT

The additive manufacturing apparatus includes: a height measurement unit outputting a measurement result of height at a measurement position of a build object formed on a workpiece during additive processing; and a control unit controlling a processing condition in performing new stacking at the measurement position in accordance with the measurement result. The height measurement unit includes a measurement illumination system irradiating the measurement position with measurement illumination light, an optical axis of the measurement illumination light is inclined with respect to an optical axis of a light receiving optical system, and the measurement illumination light is continuously emitted in an angular range of at least ±90 degrees with reference to a direction opposite a direction of supply of the processing material with the optical axis of the light receiving optical system as a center of a rotational angle range.

The present disclosure relates to an additive manufacturing apparatus that forms a build object by melting and stacking a processing material at a processing position.

### BACKGROUND

There has been known an additive manufacturing apparatus such as a 3D printer that uses a technology called additive manufacturing (AMA) in which a three-dimensional build object is formed by stacking a processing material. There is also an additive manufacturing apparatus that uses a directed energy deposition (DED) method as a method of stacking metal as the processing material. The additive manufacturing apparatus using the directed energy deposition method supplies, as the processing material, a metal material such as a metal wire or metal powder from a supply port to a base for shaping a build object, and forms the build object having a desired shape by melting and stacking the metal material using a laser or electron beam, for example.

However, in some cases, the build object formed does not have a shape as designed though the additive manufacturing apparatus moves the supply port along a predetermined path. Specifically, when the distance between an upper surface of the base and the supply port is out of an appropriate value range, the metal material cannot be stacked uniformly. When the amount of output of the metal material from the supply port is set, the height of a tip of the metal material can also be calculated. For example, in a case where the metal material is provided from the supply port located at a place at which the distance between the upper surface of the base and the supply port of the metal material is greater than the appropriate value range, in other words, in a case where the height of the build object is lower than a design value, the supplied metal material becomes a droplet to cause irregularities in the build object. On the other hand, in a case where the metal material is supplied from the supply port located at a place at which the distance between the upper surface of the base and the supply port of the metal material is less than the appropriate value range, in other words, in a case where the height of the build object is higher than the design value, the metal material is excessively pressed against the build object to generate an unmelted residue.

Thus, there has been a laser welding method in which a processing condition for next time is changed by using a weld bead shape sensor that irradiates a bead immediately after welding with a slit-shaped laser beam and measures a weld bead shape as a cross section from irregularities of a surface subjected to the measurement (See, for example, Patent Literature 1).

### CITATION LIST

### Patent Literature

Patent Literature 1: Japanese Patent Application Laid-open No. 2000-167678

### SUMMARY

### Technical Problem

However, such a conventional technique measures the bead shape by arranging the longitudinal direction of the slit-shaped laser beam to be orthogonal to the direction of travel thereof, so that when the direction of supply of the metal processing material corresponds to a +X direction, in a case of shaping in a direction other than a direction parallel to the +X direction such as in a +Y direction that is a direction orthogonal to the +X direction, the build object is not irradiated with the slit-shaped laser beam, and the height of the build object cannot be measured. Therefore, when shaping is to be performed in the +Y direction, it has been necessary to rotate a workpiece on which the build object is disposed by 90 degrees and rearrange the workpiece in a direction parallel to the +X direction and orthogonal to the longitudinal direction of the laser beam. That is, each time the processing direction changes, the processing has had to be temporarily interrupted to rotate the workpiece such that the build object can be irradiated with the laser beam.

Furthermore, for example, when processing is to be performed in three directions of a −Y direction, a −X direction, and the +Y direction, it is necessary to arrange three illumination devices that emit laser beams so as to be able to emit the laser beam in each of the three directions, which has resulted in an increase in size of the additive manufacturing apparatus.

The present disclosure has been made to solve the above-described problems, and an object thereof is to provide a simple and compact additive manufacturing apparatus that does not need to rotate a workpiece according to a direction in which a processing material is supplied.

### Solution to Problem

An additive manufacturing apparatus according to the present disclosure includes: a height measurement unit to measure a height at a measurement position of a build object formed on a workpiece and output a measurement result indicating a result of the measurement during additive processing in which the build object is formed by repeatedly stacking a processing material that is melted at a processing position on a surface of the workpiece; and a control unit to control a processing condition in performing new stacking at the measurement position in accordance with the measurement result, wherein the height measurement unit includes: a measurement illumination system to irradiate the measurement position with illumination light for measurement; a light receiving optical system to receive, by a light receiving element, reflected light obtained by reflection of the illumination light for measurement at the measurement position; and a calculation unit to calculate the height of the build object formed on the workpiece on the basis of a light receiving position of the reflected light on the light receiving element, an optical axis of the illumination light for measurement is inclined with respect to an optical axis of the light receiving optical system, and the illumination light for measurement is continuously emitted in an angular range of at least ±90 degrees with reference to a direction opposite a direction of supply of the processing material with the optical axis of the light receiving optical system as a center of a rotational angle range.

### Advantageous Effects of Invention

The additive manufacturing apparatus according to the present disclosure irradiates the angular range of ±90 degrees in the direction opposite the direction of supply of the processing material with respect to an optical axis of processing light and measures the height, so that even when the processing material is supplied from a freely selected direction, it is not necessary to rotate the workpiece according to the direction of supply of the processing material, and the build object can be manufactured with the simple and compact additive manufacturing apparatus.

### BRIEF DESCRIPTION OF DRAWINGS

FIG. 1 is a perspective view illustrating a configuration of an additive manufacturing apparatus according to a first embodiment of the present disclosure.

FIG. 2 is a diagram illustrating an internal configuration of a processing head of the additive manufacturing apparatus according to the first embodiment of the present disclosure.

FIG. 3 is a diagram illustrating dedicated hardware for implementing functions of a measurement position calculation unit, a calculation unit, and a control unit included in the additive manufacturing apparatus according to the first embodiment of the present disclosure.

FIG. 4 is a diagram illustrating a configuration of a control circuit for implementing the functions of the calculation unit and the control unit included in the additive manufacturing apparatus according to the first embodiment of the present disclosure.

FIG. 5 is a schematic diagram illustrating a height of a processing material with respect to a build object according to the first embodiment of the present disclosure.

FIG. 6 is a side view of a state in which processing is performed using the additive manufacturing apparatus according to the first embodiment of the present disclosure as viewed from a Y direction.

FIG. 7 illustrates a state in which processing is performed using the additive manufacturing apparatus according to the first embodiment of the present disclosure as viewed from an X direction, and in which line beams are projected from a measurement system illumination unit.

FIG. 8 is a side view of a state in which processing is performed such that a bead extends in a +X direction using the additive manufacturing apparatus according to the first embodiment of the present disclosure as viewed from the Y direction.

FIG. 9 is a diagram of an XY plane of the line beams projected on a flat workpiece by a measurement illumination unit according to the first embodiment of the present disclosure.

FIG. 10 is a diagram of an XY plane when a bead extending in a −X direction and ±Y directions is irradiated with the line beams according to the first embodiment of the present disclosure.

FIG. 11 is a diagram illustrating an image formed on a light receiving element when the build object is irradiated with the line beams according to the first embodiment of the present disclosure.

FIG. 12 illustrates an image on the light receiving element when processing is performed in the +Y direction using the additive manufacturing apparatus according to the first embodiment of the present disclosure.

FIG. 13 illustrates an image on the light receiving element when the additive manufacturing apparatus according to the first embodiment of the present disclosure simultaneously moves an X stage and a Y stage to perform shaping in a 135 degree direction with respect to the +X direction.

FIG. 14 is a flowchart illustrating a procedure of height control of the build object by the additive manufacturing apparatus according to the first embodiment of the present disclosure.

FIG. 15 is a diagram illustrating a height of a processing material supply unit when the additive manufacturing apparatus according to the first embodiment of the present disclosure processes a second layer.

FIG. 16 is a diagram illustrating a height of a supply port of the processing material supply unit when the additive manufacturing apparatus according to the first embodiment of the present disclosure processes the second layer.

FIG. 17 is a diagram for explaining an irradiation position of the line beams from a processing position with respect to a height of the build object.

FIG. 18 is a diagram for explaining a reference pixel position and a target height with respect to a shape of the build object.

FIG. 19 is a diagram of an XY plane of line beams projected on a flat workpiece by a measurement illumination unit according to a second embodiment of the present disclosure.

FIG. 20 is a view illustrating a configuration of an additive manufacturing apparatus according to a third embodiment of the present disclosure.

FIG. 21 is a diagram illustrating an internal configuration of a processing head of the additive manufacturing apparatus according to the third embodiment of the present disclosure.

### DESCRIPTION OF EMBODIMENTS

### First Embodiment

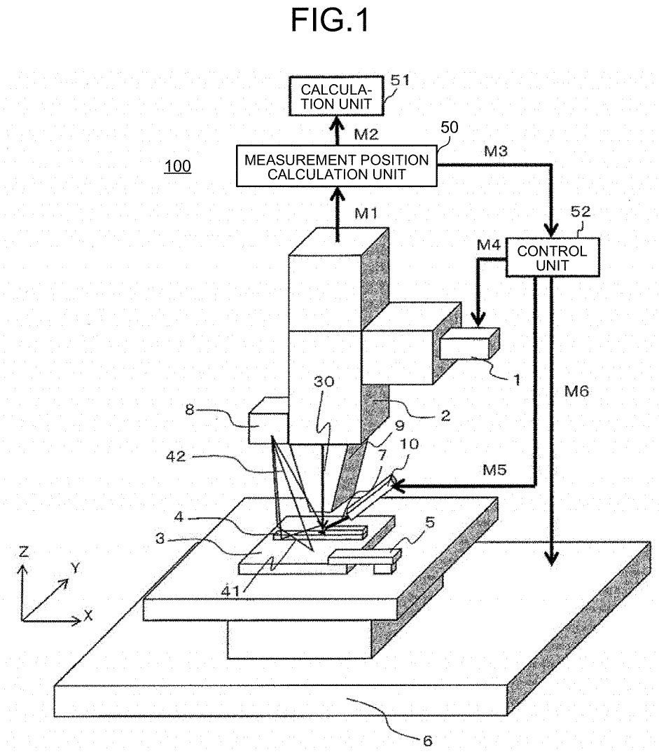

FIG. 1 is a perspective view illustrating a configuration of an additive manufacturing apparatus 100 according to a first embodiment. As illustrated in FIG. 1, the additive manufacturing apparatus 100 includes a processing laser 1, a processing head 2, a fixture 5 for fixing a workpiece 3, a drive stage 6, a measurement illumination unit 8, a gas nozzle 9, a processing material supply unit 10, a measurement position calculation unit 50, a calculation unit 51, and a control unit 52. The additive manufacturing apparatus 100 forms a build object 4 which is also called a stacked object.

Note that including the following embodiments, the additive manufacturing apparatus 100 is a metal additive manufacturing apparatus using metal as a processing material 7, but may use another processing material such as resin, for example.

Moreover, the additive manufacturing apparatus 100 melts the processing material 7 using the processing laser 1 to perform stacking processing, but may use another processing method such as arc discharge, for example.

The additive manufacturing apparatus 100 repeats additive processing of melting and adding the processing material 7 onto the workpiece 3 to form the build object 4. At this time, the additive manufacturing apparatus 100 has a function of measuring the height of the build object 4 that has been formed and controlling a processing condition for the next additive processing on the basis of a measurement result. In the first additive processing, the additive manufacturing apparatus 100 stacks the processing material 7 melted on the workpiece 3. The additive manufacturing apparatus 100 supplies the processing material 7 to a processing position and irradiates the processing position with processing light 30, thereby repeatedly performing additive processing of stacking a new layer on the build object 4 that has been formed and forming a new build object 4.

Also, the height of the build object 4 to be measured is the position of an upper surface of the build object 4 in a Z direction.

The processing laser 1 emits the processing light 30 used in shaping processing of shaping the build object 4 on the workpiece 3. The processing laser 1 is, for example, a fiber laser device using a semiconductor laser or a CO₂ laser device. The wavelength of the processing light 30 emitted from the processing laser 1 is, for example, 1070 nm.

The processing head 2 includes a processing optical system and a light receiving optical system.

The processing optical system condenses and images the processing light 30 emitted from the processing laser 1 at the processing position on the workpiece 3.

In general, the processing light 30 is condensed in a spot shape at the processing position and is thus referred to as the processing position in the description of the present embodiment below. The processing laser 1 and the processing optical system are included in a processing unit. In the present embodiment, the height of the build object 4 that has been formed at the processing position is measured by a light cutting method.

Also in the present embodiment, the light receiving optical system is disposed in the processing head 2, and the processing optical system and the light receiving optical system are integrated.

The workpiece 3 is placed on the drive stage 6 and fixed on the drive stage 6 with the fixture 5. The workpiece 3 serves as a base when the build object 4 is formed, and the processing material 7 is stacked on a surface of the workpiece 3. In the present embodiment, the workpiece 3 is a base plate but may be an object having a three-dimensional shape.

When the drive stage 6 is driven, the position of the workpiece 3 with respect to the processing head 2 changes and thus the processing position moves on the workpiece 3. Scanning of the processing position means movement of the processing position along a predetermined path. Note that the movement of the processing position involves movement in a direction orthogonal to the height direction of the build object 4. That is, the position of the processing position before the movement and the position of the processing position after the movement are different from each other in the position projected on a plane orthogonal to the height direction. Moreover, a measurement position is located in a direction in which the processing position moves on the workpiece.

The drive stage 6 is capable of scanning along three axes of X, Y, and Z axes. Note that the Z direction is the height direction in which the build object 4 is stacked. An X direction is a direction orthogonal to the Z direction, and is a direction in which the processing material supply unit 10 for supplying the processing material 7 is installed in FIG. 1. A Y direction is a direction orthogonal to both the X direction and the Z direction.

The drive stage 6 is capable of translational movement in a direction of any one of the three axes of the X, Y, and Z axes. Moreover, the drive stage 6 according to the present embodiment uses a five-axis stage that can also rotate in an XY plane and a YZ plane. The rotation in the XY plane and the YZ plane can change the attitude and position of the workpiece 3.

The additive manufacturing apparatus 100 can move an irradiation position of the processing light 30 with respect to the workpiece 3 by rotating the drive stage 6. As a result, for example, a complicated shape including a tapered shape can be shaped. The present embodiment allows the drive stage 6 to perform scanning along the five axes, but may cause the processing head 2 to perform scanning.

The additive manufacturing apparatus 100 supplies the processing material 7 to the processing position while scanning the workpiece 3 in a +X direction by driving the drive stage 6. The additive manufacturing apparatus 100 performs the additive processing by stacking the processing material 7 melted at the processing position that moves on the workpiece 3. More specifically, the additive manufacturing apparatus 100 drives the drive stage 6 to move candidate points of the processing position on the workpiece 3, so that at least one of the candidate points on the movement path serves as the processing position at which the processing material 7 is stacked.

As a result, each time the processing position is scanned, the processing material 7 is melted by the processing light 30 at the processing position and solidified after being melted, so that a bead is formed to extend in a −X direction. Every time the processing position is scanned, a bead is newly stacked on the workpiece 3 serving as the base or a part of the build object 4 that has been shaped, whereby a part of the build object 4 is newly formed. By repeating this operation, the processing material 7 is stacked so that the build object 4 as a final product is formed in a desired shape.

The processing material 7 is, for example, a metal wire or metal powder. The processing material 7 is supplied from the processing material supply unit 10 to the processing position. For example, the processing material supply unit 10 rotates a wire spool around which the metal wire is wound with the driving of a rotary motor, and feeds the metal wire to the processing position.

The processing material supply unit 10 can also pull out the metal wire supplied to the processing position by rotating the motor in a reverse direction. The processing material supply unit 10 is installed integrally with the processing head 2 and is driven integrally with the processing head 2 by the drive stage 6. Note that a method of feeding the metal wire is not limited to the above example.

The additive manufacturing apparatus 100 repeats scanning of the processing position to stack the beads generated by solidification of the processing material 7 melted, thereby forming the build object 4 on the workpiece 3. That is, the additive manufacturing apparatus 100 repeats the additive processing to generate the build object 4. The bead is an object formed by solidification of the processing material 7 melted and becomes the build object 4. In the present embodiment, an object immediately after solidification during processing is distinguished as the bead, and an object formed by solidification of the bead is distinguished as the build object 4.

In the present embodiment, the measurement illumination unit 8 is attached to a side surface of the processing head 2. In order to measure the height of the build object 4 that has been formed on the workpiece 3, the measurement illumination unit 8 emits line beams 41 and 42 for measurement in the present embodiment as illumination light toward a measurement position on the workpiece 3 or the build object 4 that has been formed.

The measurement position is a position different from the processing position and a position at which the line beams 41 and 42 for measurement are reflected, and moves with the movement of the processing position. The light receiving optical system is disposed in the processing head 2 so as to be able to receive the light reflected at the measurement position.

In addition, the light receiving optical system is disposed so as to have an optical axis in an oblique direction with respect to optical axes of the line beams 41 and 42. Since a peak wavelength of thermal radiation light generated at the time of processing is in the infrared wavelength region, it is desirable to use, as a light source of the measurement illumination unit 8, a green laser beam having a wavelength of about 550 nm or a blue laser beam having a wavelength of about 420 nm away from the peak wavelength of the thermal radiation light.

The gas nozzle 9 sprays shielding gas toward the workpiece 3 in order to prevent or reduce oxidation of the build object 4 and to cool the bead. In the present embodiment, the shielding gas is an inert gas. The gas nozzle 9 is attached to a lower portion of the processing head 2 and placed above the processing position. In the present embodiment, the gas nozzle 9 is placed coaxially with the processing light 30, but the gas may be sprayed toward the processing position from a direction oblique to the Z axis.

The measurement position calculation unit 50 calculates a future processing direction with respect to the current processing position from data of a processing path set in advance.

The measurement position calculation unit 50 will be described later in detail.

The calculation unit 51 calculates the height of the build object 4 at the processing position using a result obtained by the measurement position calculation unit 50. The height of the build object 4 is measured during processing while the processing position is moved.

The calculation unit 51 calculates the height of the build object 4 at the processing position using the principle of triangulation on the basis of a light receiving position of the reflected light of the line beams 41 and 42, which will be described in detail later.

Here, the light receiving position is a position of the line beams 41 and 42 in a light receiving element included in the light receiving optical system.

Using the height of the build object 4 calculated by the calculation unit 51, the control unit 52 controls the processing condition including, for example, a driving condition of the processing laser 1, a driving condition of the processing material supply unit 10 that supplies the processing material 7, and a driving condition of the drive stage 6. The driving condition of the processing material supply unit 10 includes a condition related to the height of the processing material 7 to be supplied.

The measurement illumination unit 8, the light receiving optical system, the measurement position calculation unit 50, and the calculation unit 51 are collectively referred to as a height measurement unit.

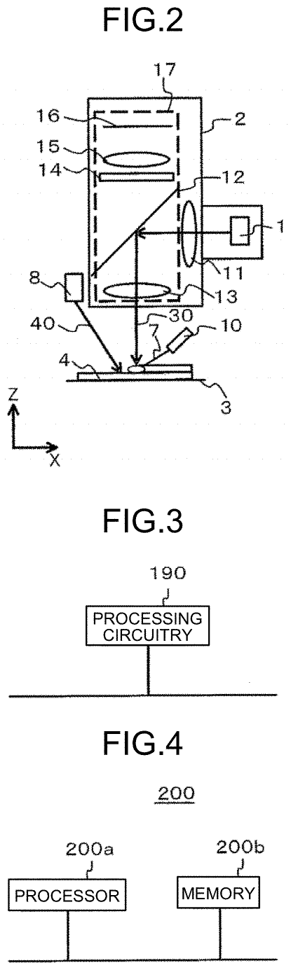

FIG. 2 is a diagram illustrating an internal configuration of the processing head 2 illustrated in FIG. 1. The processing head 2 includes a transmitter lens 11, a beam splitter 12, an objective lens 13, a band pass filter 14, a condenser lens 15, and a light receiver 16.

The transmitter lens 11 transmits the processing light 30 emitted from the processing laser 1 toward the beam splitter 12.

The beam splitter 12 reflects the processing light 30 incident from the transmitter lens 11 toward the workpiece 3.

The objective lens 13 condenses the processing light 30 incident via the transmitter lens 11 and the beam splitter 12, and images the processing light 30 at the processing position on the workpiece 3.

The processing optical system includes the transmitter lens 11, the beam splitter 12, and the objective lens 13. For example, in the present embodiment, the focal length of the transmitter lens 11 is set to 200 mm, and the focal length of the objective lens 13 is set to 460 mm. A surface of the beam splitter 12 is coated to increase the reflectance of the wavelength of the processing light 30 emitted from the processing laser 1 and transmit light having a wavelength shorter than the wavelength of the processing light 30.

Moreover, in the present embodiment, the description will be given on the condition that, as the processing direction, the workpiece 3 is scanned in the +X direction and a bead is formed to extend in the −X direction, that is, in a direction opposite to the direction in which the processing material supply unit 10 for supplying the processing material 7 is installed. Although the description will be given on the assumption that the bead is formed to extend in a linear shape including the following embodiments, for example, another bead forming method such as connecting beads formed in dot shapes to form one bead may be used. Alternatively, the bead may be a bead having a ball shape.

The line beams 41 and 42 emitted by the measurement illumination unit 8 and reflected at the measurement position enter the band pass filter 14 via the objective lens 13 and the beam splitter 12.

The beam splitter 12 transmits the line beams 41 and 42 reflected at the measurement position toward the band pass filter 14. In FIG. 2, for the sake of clarity, central axes of the line beams 41 and 42 are represented as a central axis 40.

The band pass filter 14 selectively transmits light having the wavelengths of the line beams 41 and 42 and blocks light having a wavelength other than the wavelengths of the line beams 41 and 42. The band pass filter 14 removes light having an unwanted wavelength such as the processing light 30, thermal radiation light, and ambient light, and transmits the line beams 41 and 42 toward the condenser lens 15.

The condenser lens 15 condenses and images the line beams 41 and 42 on the light receiver 16.

The light receiver 16 is, for example, an area camera equipped with the light receiving element such as a complementary metal oxide semiconductor (CMOS) image sensor. The light receiver 16 is not limited to the CMOS sensor, and need only include a light receiving element in which pixels are arranged in two dimensions.

The light receiving optical system includes the objective lens 13 and the condenser lens 15. In the present embodiment, the light receiving optical system includes the two lenses being the objective lens 13 and the condenser lens 15, but may use three or more lenses. The configuration of the light receiving optical system is not limited as long as the line beams 41 and 42 can be imaged on the light receiver 16. A light receiving unit 17 includes the light receiving optical system and the light receiving element.

Next, a hardware configuration of the measurement position calculation unit 50, the calculation unit 51, and the control unit 52 according to the present embodiment will be described. The measurement position calculation unit 50, the calculation unit 51, and the control unit 52 are implemented by processing circuitry. The processing circuitry of the measurement position calculation unit 50, the calculation unit 51, and the control unit 52 may be implemented by dedicated hardware, or may be a control circuit using a central processing unit (CPU).

When implemented by dedicated hardware, the above processing circuitry is implemented by processing circuitry 190 illustrated in FIG. 3. FIG. 3 is a diagram illustrating dedicated hardware for implementing the functions of the measurement position calculation unit 50, the calculation unit 51, and the control unit 52 illustrated in FIG. 1. The processing circuitry 190 is a single circuit, a complex circuit, a programmed processor, a parallel-programmed processor, an application specific integrated circuit (ASIC), a field programmable gate array (FPGA), or a combination of both.

When the processing circuitry 190 is implemented by the control circuit using a CPU, the control circuit according to the present embodiment is illustrated by a control circuit 200 having a configuration as in FIG. 4, for example. FIG. 4 is a diagram illustrating a configuration of the control circuit 200 for implementing the functions of the calculation unit 51 and the control unit 52 illustrated in FIG. 1.

As illustrated in FIG. 4, the control circuit 200 includes a processor 200a and a memory 200b.

The processor 200a is a CPU and is referred to as, for example, a central processor, a processing unit, an arithmetic unit, a microprocessor, a microcomputer, or a digital signal processor (DSP).

The memory 200b is, for example, a non-volatile or volatile semiconductor memory such as a random access memory (RAM), a read only memory (ROM), a flash memory, an erasable programmable ROM (EPROM), or an electrically EPROM (EEPROM (registered trademark), EM), a magnetic disk, a flexible disk, an optical disk, a compact disc, a mini disc, or a digital versatile disk (DVD).

When implemented by the control circuit 200, the processing circuitry 190 is implemented by the processor 200a reading and executing a program stored in the memory 200b, the program corresponding to the processing of each component. The memory 200b is also used as a temporary memory for each processing executed by the processor 200a.

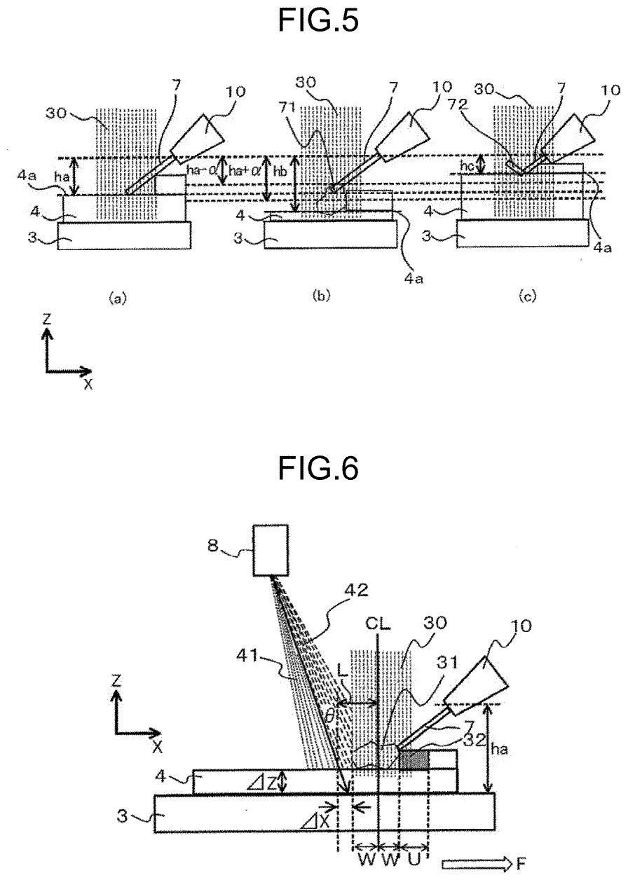

FIG. 5 is a schematic diagram illustrating a height of the processing material 7 with respect to the build object 4 according to the present embodiment. In FIG. 5, the height of the processing material 7 is a length between an upper surface 4a of the build object 4 that has been formed and a supply port for the processing material 7 of the processing material supply unit 10. The height of the processing material 7 will be described with reference to FIG. 5.

When an amount of output of the processing material 7 from the supply port is set, the height of a tip of the processing material 7 can be calculated. Moreover, an appropriate height range of the processing material 7 depends on the height of the build object 4 that has been shaped. As illustrated in FIG. 5, if the processing material 7 fails to be supplied at an appropriate height corresponding to the build object 4 that has been formed, a defect is generated in a processing result.

The appropriate height range of the processing material 7 corresponding to the build object 4 that has been formed will be described with reference to FIG. 5. In FIG. 5, the appropriate height range of the processing material 7 is represented by ha±α.

In a portion (a) in FIG. 5, a height “ha” of the processing material 7 is within the range of ha±α. Therefore, no defect is generated in the processing result.

In a portion (b) in FIG. 5, the height of a bead that has been formed and serves as a surface subjected to processing is lower than a predetermined design value, and a height “hb” of the processing material 7 satisfies hb>ha+α and is out of the range of ha±α. Therefore, the processing material 7 melted by being irradiated with the processing light 30 does not sufficiently adhere to the build object 4 that has been formed, whereby a droplet 71 is generated to cause irregularities in the build object 4 after processing.

In a portion (c) in FIG. 5, the height of a bead that has been formed and serves as the surface subjected to processing is higher than the design value, and a height “hc” of the processing material 7 satisfies hc<ha−α and is out of the range of ha±α. Therefore, the processing material 7 is excessively pressed against the build object 4 that has been formed, whereby the processing material 7 is not completely melted even when irradiated with the processing light 30, and an unmelted residue 72 of the processing material 7 is generated. As a result, the processing material 7 remaining unmelted is contained in the build object 4 after processing.

As illustrated in FIG. 5, it is essential for highly accurate processing to keep the height of the processing material 7 corresponding to the build object 4 that has been formed at an appropriate value during processing.

In a case of a first layer in which the build object 4 starts to be manufactured on the workpiece 3, if the height of the workpiece 3 is even, the processing need only be performed while maintaining the height of the processing material 7 constant. However, in second and subsequent layers, the height of the build object 4 that has been formed up to the previous layer may not be as high as the design value. In the case where the height is not as high as the design value, even when the metal material is raised by the design height of one layer from the height of the processing material 7 at the time of stacking, in practice, the height of the processing material 7 may not fall within the appropriate range for the processing material 7 corresponding to a portion subjected to stacking this time at a portion where the height of the build object 4 up to previous stacking is different from the design value. Moreover, the height of the build object 4 may not be constant depending on the position.

Even if the height of the second layer falls within ha±α, which is the appropriate height range, when processing is performed a plurality of times and an n-th layer (n≥2) is processed, a stacking error is added “n” times, so that the height may not fall within ha±α being the appropriate height range.

Therefore, the present embodiment measures the height of the build object 4 that has been formed during processing, and controls the processing condition on the basis of the measurement result. By measuring the height of the build object 4 that has been formed during processing, both the additive processing and the measurement of the height of the build object 4 that has been formed can be performed while performing scanning of the processing path for the additive processing of one layer once, and the additive processing can be efficiently performed.

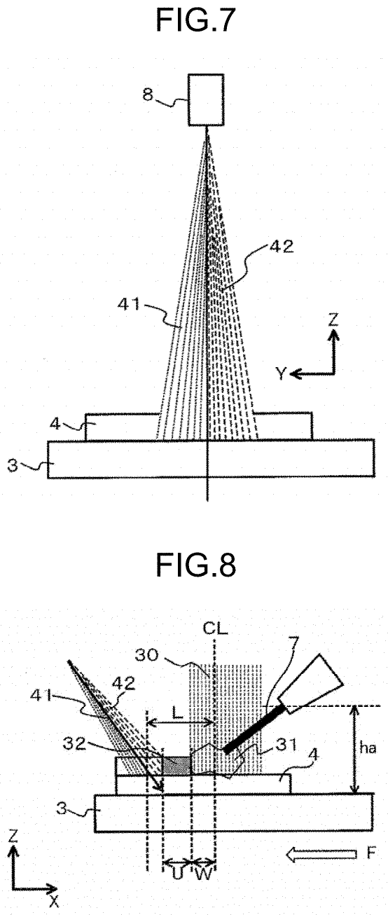

Next, with reference to FIGS. 6 and 7, a description will be given of a height measuring operation using the light cutting method for measuring a bead height after processing by using the height of the build object 4 that has been formed in order to maintain the processing material 7 at an appropriate height with respect to the build object 4 that has been formed.

FIG. 6 is a side view of a state in which processing is performed using the additive manufacturing apparatus 100 of the present embodiment as viewed from the Y direction. In the present embodiment, the line beams 41 and 42 are projected from the measurement illumination unit 8.

FIG. 6 illustrates a state in which a bead is processed so as to extend in the −X direction that is a direction opposite a supply position of the processing material 7 with respect to an optical axis CL of the processing light 30.

FIG. 7 illustrates a state in which the line beams 41 and 42 are projected from the measurement illumination unit 8 as viewed from the X direction.

In the present embodiment, as illustrated in FIG. 6, the measurement illumination unit 8 is installed in a direction opposite a direction of supply of the processing material 7 of the processing material supply unit 10 with respect to the optical axis CL of the processing light 30. In addition, as illustrated in FIG. 7, the measurement illumination unit 8 is assumed to be installed on the X axis.

In FIG. 6, the height of the build object 4 with respect to the upper surface of the workpiece 3 is denoted by AZ, and the irradiation angle of the line beams 41 and 42 is denoted by θ.

When ΔX is a difference between an irradiation position of the line beams 41 and 42 on the upper surface of the workpiece 3 and an irradiation position L of the line beams 41 and 42 on the build object 4, ΔX is represented by ΔX=ΔZ×tan θ. In the present embodiment, the optical axis of the light receiving optical system corresponds to a vertical direction coaxial with the optical axis CL of the processing light 30, so that the optical axes of the line beams 41 and 42 are inclined by θ with respect to the optical axis of the light receiving optical system.

As described above, in the case where the measurement illumination unit 8 is installed in the −X direction with respect to the light receiving optical system, and the line beams 41 and 42 are emitted while being inclined by θ with respect to the optical axis of the light receiving optical system in the XZ plane, a shift of the projection positions of the line beams 41 and 42 when the height changes occurs in the X direction regardless of the measurement position within the angular range of ±90 degrees centered on the direction opposite the +X direction that is the direction in which the processing material 7 is supplied.

An arrow F indicates a state in which the drive stage 6 on which the workpiece 3 is placed moves in the +X direction.

Also in FIG. 6, the position for measuring the height of the build object 4 that has been formed is a position shifted in the −X direction with respect to the processing position. As illustrated in FIG. 6, if the drive stage 6 is scanned in the +X direction, the processing position moves on the workpiece 3 in the −X direction and thus the build object 4 having a linear shape can be manufactured so as to extend in the −X direction.

A region where the processing position is irradiated with the processing light 30 at the time of additive processing with the processing material 7 melted on the workpiece 3 is defined as a melt pool 31. In FIG. 6, the build object 4 is already formed on the workpiece 3, and the melt pool 31 that is the region where the processing material 7 is melted is on the build object 4.

An edge of the melt pool 31 is assumed to be at a position separated by a distance W from the optical axis CL of the processing light 30 that is the center of the processing position. Also, a high temperature portion 32 where the bead has a high temperature and is not sufficiently solidified is assumed to be at a position separated by a distance U from the edge of the melt pool 31.

Moreover, in the present embodiment, the optical axis CL of the processing light 30 corresponds with the optical axis of the light receiving optical system.

The vicinity of the melt pool 31 at the processing position has high temperature, and when the drive stage 6 is moved in the +X direction, the melt pool 31 is naturally cooled. Meanwhile, the high temperature portion 32 is generated on the outer side of the melt pool 31 after processing in the +X direction, and is solidified into a certain shape as a bead of the processing material 7 after a sufficient time elapses. The build object 4 is formed by stacking of the bead.

The direction in which the processing position moves on the workpiece 3 indicates a direction along the path of movement of the processing position. The high temperature portion 32 is generated in a direction opposite to the direction in which the processing position moves on the workpiece 3.

In the case of FIG. 6, since the processing position moves on the workpiece 3 in the −X direction, the high temperature portion 32 is generated in the +X direction with respect to the processing position. On the other hand, the height of the build object 4 that has been formed is measured at a position in the −X direction that is the same direction as the direction in which the processing position moves on the workpiece 3.

In the melt pool 31, the processing material 7 is melted, which decreases the measurement accuracy of the height of the build object 4 that has been formed. Moreover, since the melt pool 31 has a temperature high enough to melt the metal processing material 7, thermal radiation light having very high brightness is generated and is likely to interfere with the height measurement. Therefore, the measurement position is desirably at a position at least W or more away from the center of the processing position. That is, it is desirable that the measurement position do not overlap with the melt pool 31.

Moreover, in a case where the measurement position is set in the melt pool 31, because the bead is not completely solidified and is in a liquid state, there is a possibility that the measurement illumination is not sufficiently reflected and an illuminance distribution on the bead cannot be measured. In addition, since melting occurs differently depending on the measurement position, a measurement error occurs in the bead height with respect to the measurement position. An error occurs between a state after solidification and a molten state due to thermal contraction of the metal.

Therefore, as described above, by setting the measurement position away from the melt pool 31, it is possible to separate the thermal radiation light from the processing position and the reflected light of the line beams 41 and 42.

However, in a case where sufficient measurement accuracy can be obtained for the required shaping accuracy of the build object 4, the vicinity of the processing position such as on the melt pool 31 or the high temperature portion 32 may be measured.

Since the additive manufacturing apparatus 100 of the present embodiment performs the measurement in the direction of movement of the processing position with respect to the processing position, the height of the build object 4 can be measured with high accuracy without being affected by the bead melted in the high temperature portion 32 as long as the measurement position is separated from the edge of the melt pool 31.

Here, FIG. 6 illustrates the case where the bead is processed so as to extend in the −X direction that is the direction opposite to the processing material supply unit 10, but the bead can also be processed so as to extend in the +X direction that is the same direction as the processing material supply unit 10.

Next, FIG. 8 is a side view of a state in which processing is performed such that a bead extends in the +X direction using the additive manufacturing apparatus 100 of the present embodiment as viewed from the Y direction.

In FIG. 8, the position for measuring the height of the build object 4 that has been formed is a position shifted in the −X direction with respect to the processing position. The high temperature portion 32 lies within a distance of W+U from the center of the processing position in the −X direction with respect to the processing position. In the high temperature portion 32, the bead is not completely solidified, so that the accuracy of measuring the height of the build object 4 is reduced.

Therefore, in the case where the height is measured at the position shifted in the −X direction with respect to the processing position, the irradiation position L of the line beams 41 and 42 on the build object 4 is more desirably set to a position separated from the center of the processing position by at least the distance of W+U or more. That is, it is more desirable that the measurement position where the height is measured is a position outside the range in which the processing material 7 is melted at the time of processing. However, in a case where sufficient measurement accuracy can be obtained for the required shaping accuracy of the build object, the vicinity of the processing position may be measured.

As in FIG. 8, even in the case where the measurement position is set in the same direction as the direction in which the high temperature portion 32 is generated with respect to the processing position, if the irradiation position L of the line beams 41 and 42 on the build object 4 is sufficiently far from the processing position, the bead is sufficiently solidified as well.

However, in a case where the irradiation angles of the line beams 41 and 42 are fixed, it is necessary to install the measurement illumination unit 8 and the light receiving optical system at positions away from the processing head 2, which results in an increase in size of the apparatus.

It is also necessary to determine the magnification of the light receiving optical system so as to increase the field of view such that the line beams 41 and 42 enter an imaging area of the light receiver 16, which causes a problem in that the resolution per pixel of the light receiver 16 is reduced. It is also possible that measurement cannot be performed with a configuration in which the processing head 2 and the measurement illumination unit 8 are integrated.

Therefore, when the height measurement position is set in the direction in which the processing position moves on the workpiece 3 as viewed from the processing position, that is, in the direction of travel of the processing path, the height can be measured at a position close to the processing position. That is, as in FIG. 6, by setting the measurement position in the direction opposite to the direction in which the high temperature portion 32 is generated with respect to the processing position, the measurement can be performed at a position close to the processing position without being affected by the bead having a high temperature and being melted without being solidified.

In the additive manufacturing apparatus 100 of the present embodiment, as in FIG. 6, the line beams 41 and 42 are emitted in the direction of travel of the processing path when viewed from the processing position, but the configuration of FIG. 8 may be adopted.

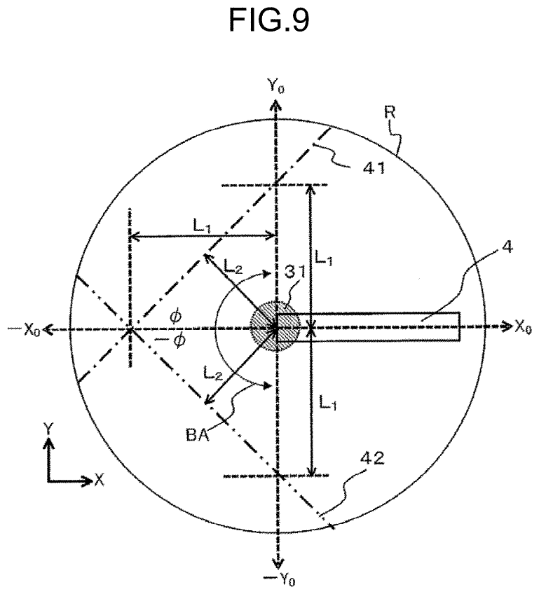

FIG. 9 is a diagram of an XY plane of the line beams 41 and 42 projected on the workpiece 3 that is flat by the measurement illumination unit 8 used in the present embodiment. In FIG. 9, the center of the processing position is set at an intersection of an X0 axis and a Y0 axis, and the direction in which the processing material 7 is supplied, that is, the direction in which the processing material lies as viewed from the processing position is set to a +X0 direction. The description will be made using FIG. 9 in which the +X0 direction is set to a 0 degree direction, a +Y0 direction is set to 90 degrees, a −X0 direction that is a direction opposite the direction in which the processing material 7 is supplied is set to 180 degrees, and a −Y0 direction is set to a 270 degree direction.

The line beam 41 is projected while its length direction is rotated by φ from the X axis with respect to the optical axis of the line beam 41 of the measurement illumination unit 8 so as to cross the −X0 direction and the +Y0 direction with respect to the processing position. The length of the line beam 41 refers to the length of the beam projected on a target object, not the irradiation width that is the thickness when the line beam 41 is projected.

The line beam 42 is projected while its length direction is rotated by φ from the X axis with respect to the optical axis of the line beam 42 of the measurement illumination unit 8 so as to cross the −X0 direction and the −Y0 direction with respect to the processing position.

In FIG. 9, the line beams 41 and 42 intersect on the −X0 axis but need not strictly intersect. For example, one of the lines may be bent.

That is, it is sufficient that the line beams are continuously emitted in an angular range of at least ±90 degrees with reference to the −X0 direction, which is a range represented by BA in FIG. 9, with the optical axis CL of the processing light 30 as the center of the angular range.

Desirably, like the line beams 41 and 42 in FIG. 9, it is preferable to perform irradiation in the range of at least ±90 degrees or wider with reference to the −X direction. It is because in a case where a bead formed in the ±Y0 directions is measured, for example, the accuracy of obtaining the height of the build object 4 increases when the line beams are emitted so as to cross the bead.

Moreover, the position where the line beams 41 and 42 intersect need not be strictly on the X0 axis, and need only be within the angular range of ±90 degrees with reference to a direction opposite the +X0 direction relative to the optical axis CL of the processing light 30. In addition, although the amounts of rotation of the length direction of the line beams 41 and 42 from the X0 axis are different in direction but the same in value of φ, the value need not be strictly the same. That is, the line beams need only be emitted within the angular range of ±90 degrees with reference to the direction opposite the +X0 direction relative to the optical axis CL of the processing light 30.

It is sufficient that the line beams are emitted over the angular range of at least ±90 degrees or wider with reference to the direction opposite the direction of supply of the processing material 7 with the optical axis CL of the processing light 30 lying therebetween, so that the line beams 41 and 42 in the present embodiment have linear shapes but need not be strictly linear, that is, may be curved lines or wavy lines, for example.

In addition, as illustrated in FIG. 6, the projection position L of the line beam in each direction is desirably separated by the distance W from the center of the processing position. For example, when the measurement position on the build object in the −X0 direction and the ±Y0 directions is at a distance L1 from the processing position, it is desirable that a distance L2 of the measurement position from the processing position in each of a 135 degree direction (midpoint between the +Y0 direction and the −X0 direction) and a 225 degree direction (midpoint between the −Y0 direction and the −X0 direction) where the measurement position is closest to the processing position is equal to W or more.

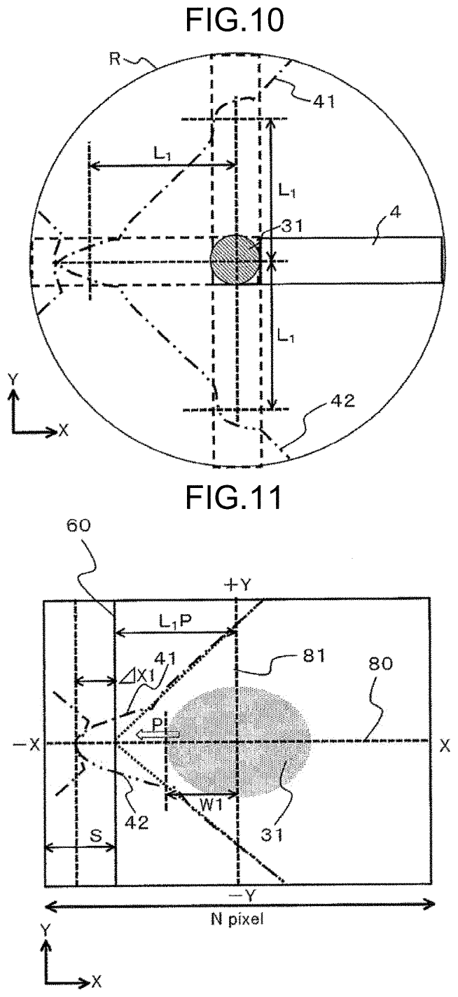

FIG. 10 is a diagram of an XY plane when a bead extending in the −X direction and the ±Y directions is irradiated with the line beams. Since the height of the line beams emitted on the bead is different from that on a flat portion, the irradiation positions of the line beams are shifted in the X direction according to the height of an object by the principle of triangulation.

FIG. 11 is a diagram illustrating an image formed on the light receiving element when the build object 4 is irradiated with the line beams 41 and 42 according to the present embodiment. In the present embodiment, a line of an X-direction pixel center 81 of the processing position is set to the center in the X direction on the light receiving element, and a line of a field-of-view center 80 is set to the center in the Y direction on the light receiving element, but the present disclosure is not limited thereto. Moreover, the measurement position is within the field of view of the light receiving element.

As illustrated in FIG. 6, in the XZ plane, the optical axes of the line beams 41 and 42 are inclined by θ with respect to the optical axis CL of the processing light 30 of the light receiving optical system, the optical axis CL corresponding to the vertical direction in the present embodiment.

In a case where the measurement is performed during processing, the processing position is a high-luminance light emitting point, so that an image of the melt pool 31 appears at the center of the image. In FIG. 11, the center of the melt pool 31 is set to the image center in the X direction, and a width W1 of the melt pool 31 on the light receiving element is W1=M×W using a magnification M of the light receiving optical system. By installing the band pass filter 14 in the light receiving optical system and setting the output of the measurement illumination unit 8 sufficiently high, the height of the build object 4 can be measured from the projection position of the line beams 41 and 42 on the light receiving element without being affected by the light emission in the melt pool 31. Furthermore, the projection position in the X direction of the line beams 41 and 42 at a position corresponding to the processing position in the Y direction corresponds to the height of the build object 4.

In FIG. 11, when processing is performed in the −X direction, the height of the build object 4 can be calculated from the projection position of the line beams 41 and 42 on the X axis.

An X-direction pixel position serving as a reference of the shift of the centroid on the light receiving element at the time of height calculation is set as a reference pixel position. In the present embodiment, the X-direction pixel position of the projection position of the line beams 41 and 42 on the light receiving element when the light receiving optical system is adjusted to the focal position is set as a reference pixel position 60. In the present embodiment, since the line beams 41 and 42 are rotated with respect to the X axis, the reference pixel position 60 is different for each Y-direction pixel. For example, in FIG. 11, the reference pixel position 60 is the projection position of the line beams 41 and 42 corresponding to the focal point of the light receiving optical system, and is a position away from the X-direction pixel center 81 by LIP.

Moreover, in the present embodiment, the reference pixel position 60 is the X-direction projection position of the line beams 41 and 42 when adjustment is made to the focal point of the light receiving optical system, but can be set at will. In addition, the focal points of the line beams 41 and 42 are desirably set at the same height as the focal point of the light receiving optical system.

As described above, the X-direction position of the light receiving element serving as the reference pixel position 60 varies depending on the processing direction, that is, the Y-direction position on the light receiving element. Therefore, it is necessary to calculate the measurement position, that is, the Y-direction position on the light receiving element from a future processing direction with respect to the current processing position.

The measurement position calculation unit 50 thus calculates the future processing direction with respect to the current processing position from data of a processing path set in advance. As a result, it is possible to calculate the Y-direction position on the light receiving element at which the centroid is calculated.

The future processing direction is expressed as an angle on the XY plane with respect to the processing position. For example, in FIG. 11, the processing direction is a 180 degree direction with respect to the +X direction. At an intersection of the projection positions of the line beams 41 and 42 on the light receiving element and a processing direction P when adjustment is made to the focal point of the light receiving optical system, the Y-direction position coincides with the position of the field-of-view center 80, that is, on the X axis same as the processing position, whereby the height of the build object 4 can be calculated by calculating the centroid position in the X direction for the field-of-view center 80 in the Y direction and finding a difference between the calculated position and the reference pixel position 60.

From a difference between the height of the build object 4 and the reference pixel position 60, the irradiation positions of the line beams 41 and 42 are projected while shifted by ΔX1, where ΔX1=M×ΔX.

Assuming that “p” is the size of one pixel of the light receiver 16, a height displacement ΔZ1 per pixel is expressed as ΔZ1=p×tan θ/M. For example, when p=5.5 μm, M=½, and θ=72 deg, the height displacement is ΔZ1=33.8 μm.

The height of the build object 4 can thus be calculated by the principle of triangulation from the projection positions of the line beams 41 and 42 formed in the light receiver 16.

Moreover, in a case where the additive processing is performed for a plurality of layers, the drive stage 6 is raised by a certain amount in the Z direction every time each layer is stacked, so that the heights of the processing head 2 and a height sensor with respect to the upper surface of the workpiece 3 are raised.

That is, the focal position of the height sensor is also raised as the drive stage 6 is raised. Therefore, the height in the Z direction to be the reference pixel position 60 also increases.

By repeating the calculation of the difference from the reference pixel position 60 as described above, even when the height of the build object 4 becomes higher with respect to the upper surface of the workpiece 3 and the reflected light of the line beams 41 and 42 from the upper surface of the workpiece 3 cannot be received, the height of the build object 4 can be calculated from an integral value of the amount of increase in the Z axis so far and the difference between the irradiation positions of the line beams 41 and 42 reflected from the upper surface of the build object 4 in the field of view on the light receiving element and the reference pixel position 60.

Here, when “D” is a range of the height to be measured with reference to the height of the focal point of the light receiving optical system, an amount of movement S of the line beams 41 and 42 with respect to the distance D is represented by S=D×M/tan θ, so that it is desirable to design the number of pixels N in the X direction of the light receiving element such that the field of view of W+S with respect to the distance W from the image center to the edge of the melt pool 31 can be secured at the minimum as the light receiving optical system.

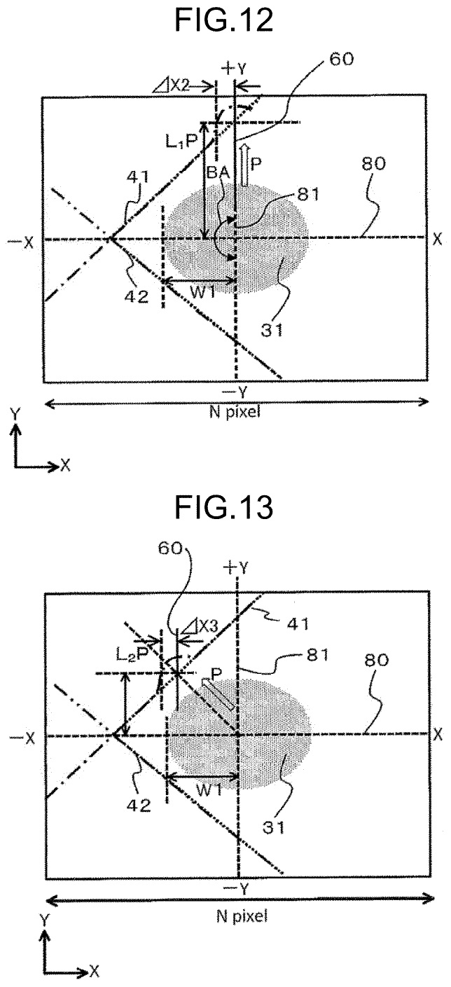

Next, as an example other than the case where shaping is performed in the direction parallel to the direction of supply of the processing material 7, the present embodiment will describe a case where shaping is performed in the +Y direction. FIG. 12 illustrates an image on the light receiving element when processing is performed in the +Y direction. The line beams are continuously emitted in an angular range of at least ±90 degrees with reference to the −X direction, which is a range represented by BA in FIG. 12, with the optical axis CL of the processing light 30 as the center of the rotational angle range. As a result, even when shaping is performed in a direction other than the −X direction as in FIG. 11, the height of the build object 4 can be measured.

In addition, FIG. 13 illustrates an image on the light receiving element when an X stage and a Y stage are simultaneously moved to perform shaping in an oblique direction such as in the 135 degree direction with respect to the +X direction, for example.

In FIG. 12, since the processing is performed in the +Y direction, the intersection of the projection positions of the line beams 41 and 42 on the light receiving element and the processing direction P when adjustment is made to the focal point of the light receiving optical system is in the 90 degree direction with respect to the +X direction, and the reference pixel position 60 on the light receiving element is in the +Y direction from the processing position. Therefore, the Y-direction pixel used as the reference pixel position 60 is at a position away from the center of the field of view by LIP in the +Y direction, and when ΔX2 is a difference between the projection position of the line beam 41 in the X direction and the reference pixel position 60, the height of the build object 4 can be calculated from ΔX2.

Moreover, in FIG. 13, since the X stage and the Y stage are simultaneously moved to perform shaping in the 135 degree direction with respect to the +X direction, the intersection between the projection positions of the line beams 41 and 42 on the light receiving element and the processing direction P when adjustment is made to the focal point of the light receiving optical system is at the position away from the center of the field of view by L₂P in the Y direction, and when ΔX3 is a difference between the projection position of the line beam 41 in the X direction and the reference pixel position 60, the height of the build object 4 can be calculated from ΔX3.

In the present embodiment, the range of 90 degrees to 180 degrees on the upper side with respect to the X axis has been described, but the height of the build object 4 can be similarly calculated for 180 degrees to 270 degrees on the lower side with respect to the X axis.

As described above, since the height of the build object 4 can be calculated from the difference between the projection positions of the line beams 41 and 42 in the X direction and the reference pixel position 60 regardless of the processing direction, it is not necessary to change the direction of the centroid calculation for each processing direction. Even if the measurement position is changed, the centroid position of the line beams on the light receiving element need only be calculated in the X direction, so that the height calculation processing is simple.

As the height of the build object 4, a value calculated from one pixel in the Y direction may be used, or an average of a plurality of pixels may be used. In the case of using the plurality of pixels, the height of the build object 4 can be calculated by calculating a difference between the reference pixel position 60 set in advance for each Y direction and the centroid position calculated, and calculating an average thereof.

The irradiation positions of the line beams 41 and 42 are typically calculated from the centroid position in the X direction of the projection patterns of the line beams 41 and 42.

The calculation unit 51 calculates an output in the X direction for each Y-direction pixel, and calculates the centroid position from a cross-sectional intensity distribution of the line beams 41 and 42.

The method of calculating the irradiation positions of the line beams 41 and 42 is not limited to the calculation of the centroid position but is selected as appropriate such as calculation of a peak position of the amount of light.

The irradiation widths of the line beams 41 and 42 need to be sufficiently wide for the calculation of the irradiation positions.

For example, in the case of the centroid calculation, the centroid cannot be calculated if the irradiation widths are too narrow, or if the irradiation widths are too wide, an error is likely to occur due to the influence of a change in the intensity patterns of the line beams 41 and 42. Therefore, the irradiation width is desirably about 5 to 10 pixels.

As described above, the centroid position in the X direction is calculated for each pixel in the Y direction of the image, and the result is converted into the height to be able to measure a cross-sectional distribution of the height of the build object 4 in the width direction of the build object 4.

However, it is not necessary to calculate the height by calculating the centroid for all pixels in the Y direction of the projected line beams. For example, if only the measurement position calculated from the processing path suffices, only a region of the Y-direction position of the measurement position may be used.

In the description of the present embodiment, the measurement illumination unit 8 is on the −X axis but need not be strictly on the −X axis. The installation position is not limited as long as the line beams 41 and 42 of the measurement illumination unit 8 are emitted with the optical axes thereof being inclined from the optical axis CL of the processing light 30 of the light receiving optical system.

In the case of the configuration in which the processing material 7 is supplied from the side surface of the processing head 2 as in the present embodiment, the installation position is desirably in the range from the −Y direction to the −X direction and the +Y direction, which is the ±90 degree direction with reference to the direction opposite the direction in which the processing material 7 is supplied, that is, in the range from 90 to 270 degrees. However, the range may be wider.

Moreover, although the measurement illumination unit 8 has been described to emit the line beams 41 and 42 from one illumination device, two illumination devices may be disposed close to each other to each emit the line beam, or one illumination device and an optical element such as a hologram element may be used to generate a beam shape.

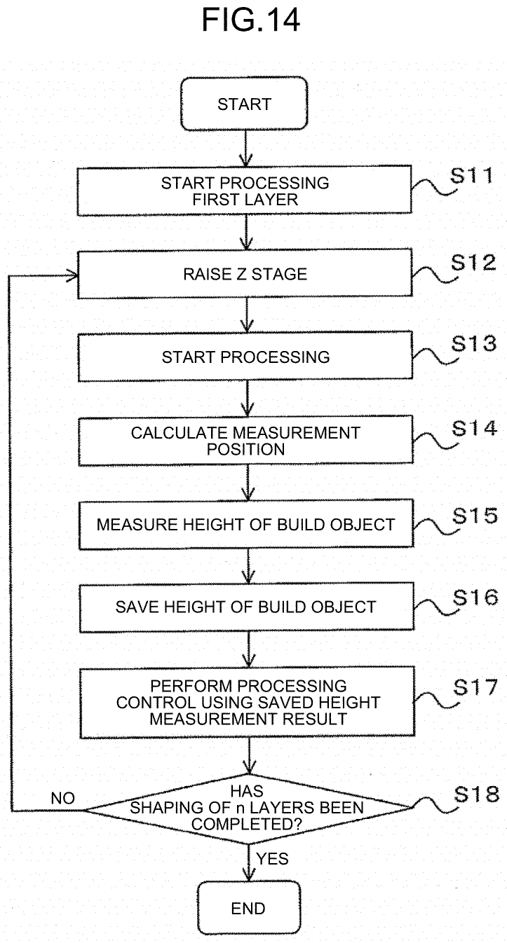

FIG. 14 is a flowchart illustrating a procedure of height control of the build object 4 according to the present embodiment. In FIG. 14, a case of shaping a stacked object having “n” layers will be described.

First, in step S11, the additive processing of a first layer is started. Since the workpiece 3 is the base plate having the flat upper surface with no bead at the measurement position at the time of the additive processing of the first layer, it is not necessary to measure the height of the build object 4, so that a step of measuring the height in FIG. 14 is omitted. However, for example, when a bead is stacked on the build object 4 or when the base plate is distorted, the height of the build object 4 may be measured from the first layer in order to perform the additive processing accurately.

In step 12, the additive manufacturing apparatus 100 raises the drive stage 6 in the Z direction in order to perform the additive processing of a second layer after completing the additive processing of the first layer.

In step 13, the additive manufacturing apparatus 100 starts the additive processing of the second layer.

In step 14, the measurement position calculation unit calculates the Y-direction position on the light receiving element to be a measurement point.

In step 15, with the start of the additive processing, the height of the build object 4 is measured from a difference between the projection positions of the line beams 41 and 42 and the reference pixel position.

In step 16, a measurement result of the height of the build object 4 for the measurement position is saved.

In step 17, when the next processing is performed at the measured position of the build object 4, processing control is performed using the measurement result saved in step S16. The interval at which the height of the build object 4 can be measured in step S15 is determined by the frame rate of an image sensor used as the light receiving element in the light receiver 16 and the scanning speed for the processing position. For example, when the frame rate is F [fps] and the speed of movement of the drive stage 6 is v [mm/s], a measurement interval Λ [mm] of the height of the build object 4 in the scanning direction of the processing position is Λ=v/F. Therefore, when “L” is the distance from the processing position to the measurement position, a measurement result obtained L/Λ periods ago serves as the measurement result corresponding to the current processing position.

In practice, since the position of the stage at the processing position and the measurement position are associated with each other, it is possible to refer to the measurement result of the current processing position. That is, when an n-th layer is processed, the height of the stacked object of an (n−1)-th layer at a certain measurement position is measured, and after L/Λ periods from this measurement, the measurement result being the processing position is used to perform optimal processing control.

In step S17, the control unit 52 controls the processing condition for newly stacking a layer at the measurement position according to the measurement result.

Finally, in step S18, the additive manufacturing apparatus 100 determines whether or not shaping of the n layers has been completed.

If No in step S18, that is, if shaping of the n layers has not been completed, the additive manufacturing apparatus 100 returns to the processing of step S2. If Yes in step S8, that is, if shaping of the n layers has been completed, the additive manufacturing apparatus 100 ends the additive processing.

The additive manufacturing apparatus 100 repeats the processing of steps S12 to S18 to be able to obtain the build object 4 having a freely selected shape by the stacking processing.

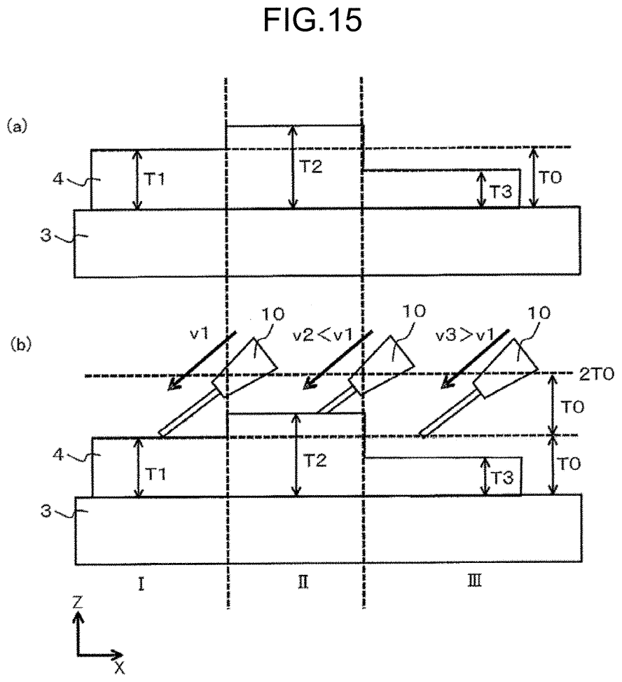

FIG. 15 is a diagram illustrating the height of the processing material supply unit 10 when the additive manufacturing apparatus 100 processes the second layer. In FIG. 15, a target stacking height of the build object 4 formed in the first layer is indicated by T0. The upper surface of the workpiece 3 is used as a reference for the height. In region I, the stacking height of the build object 4 formed in the first layer is represented by T1. Similarly, the height of the build object 4 formed in the first layer is represented by T2 in region II and T3 in region III. A method of processing control will be described with reference to FIG. 15.

In a portion (a) in FIG. 15, in region I, the stacking height T1 of the build object 4 formed in the first layer is assumed to be the same as the target stacking height T0, that is, T1=T0. In region II, the stacking height T2 of the build object 4 formed in the first layer is assumed to be higher than the target stacking height T0, that is, T2>T0. In region III, the stacking height T2 of the build object 4 formed in the first layer is assumed to be lower than the target stacking height T0, that is, T3<T0.

In the present embodiment, for the sake of simplicity, it is assumed that the build object 4 can be processed to have the target stacking height when the height of the surface subjected to shaping of the build object 4 is equal to the height of the tip of the processing material 7 as in FIG. 15. That is, when the stacking height T1 of the build object 4 formed in the first layer is the same as the target stacking height T0, that is, T1=T0, the height of the tip of the processing material 7 for stacking the second layer to have the target stacking height T0 is assumed to be the same as the target stacking height T0 of the build object 4 of the first layer, but need not be the same.

A description will be given of the processing condition for changing a stacking amount with reference to a portion (b) in FIG. 15.

The processing condition for changing the stacking amount is, for example, a parameter such as processing laser output, a feed speed of the processing material 7, or a feed speed of the stage.

The present embodiment will describe a case where the feed speed of the processing material 7 is controlled.

When the feed speed of the processing material 7 is controlled, the amount of supply of the processing material 7 to be fed to the processing position during irradiation with the processing light 30 can be controlled. The feed speed of the processing material 7 for stacking a layer to have the target stacking height T0 is expressed as v1.

At the time of processing of the second layer in region I, since the measurement result T1 of the first layer is the same as the target stacking height T0, the processing condition is not changed so that the feed speed of the processing material 7 is set to v1.

At the time of processing of the second layer in region II, since the measurement result T2 of the first layer is higher than the target stacking height T0, the stacking amount of the second layer is 2×T0−T2.

Therefore, the control unit 52 controls a feed speed v2 of the processing material 7 to be slower than v1, that is, V2<V1. The amount of supply of the processing material 7 is reduced so that the height of the build object 4 equals 2λT0 at the end of processing the second layer on top of the first layer.

Similarly, at the time of processing of the second layer in region III, since the measurement result T3 of the first layer is lower than the target stacking height T0, the stacking amount of the second layer is 2×T0−T3. Therefore, the control unit 52 controls a feed speed v3 of the processing material 7 to be faster than v1. The amount of supply of the processing material 7 is increased so that the height of the build object 4 equals 2×T0 at the end of processing the second layer on top of the first layer.

That is, the processing condition is controlled by the control unit 52 according to the difference between the preset height of the stacked object to be newly stacked on the build object 4 and the measurement result.

The control value for the feed speed of the processing material 7 need only be obtained by calculating and holding in advance the relationship between the feed speed of the processing material 7 and the height of the bead to be stacked. Moreover, in a case where a plurality of layers are stacked, the control value may be dynamically changed during the stacking processing using a result of stacking based on a measured bead height of a previous layer.

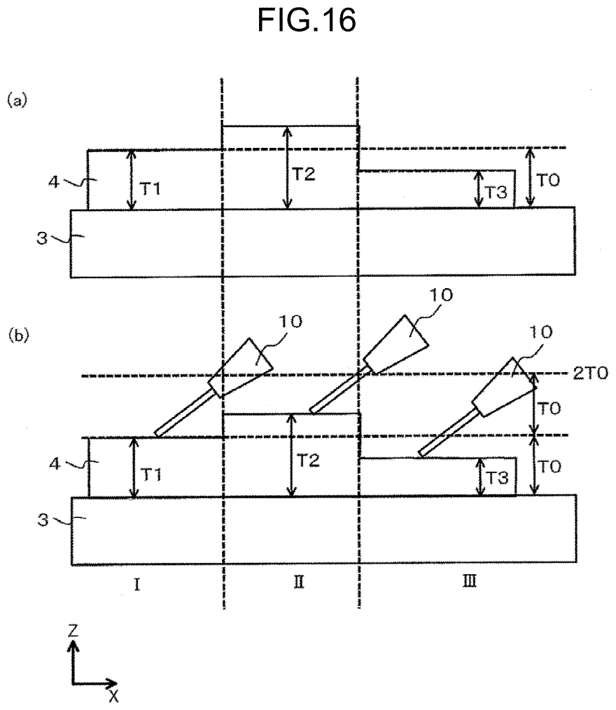

FIG. 16 is a diagram illustrating the tip portion of the processing material in a case of processing the second layer, in order to illustrate a method in which the additive manufacturing apparatus 100 controls the height of the supply port of the processing material supply unit 10 on the basis of the measurement result of the height of the build object 4. A state at the end of processing of the first layer is assumed to be similar to that in FIG. 15.

In region II and region III, the height of the build object 4 of the first layer greatly deviates from the target height T0, and thus when the processing material supply unit 10 is raised by T0 at the time of additive processing of the second layer, the height of the supply port of the processing material supply unit 10 relative to the surface subjected to the additive processing may not fall within the allowable range of ha±α illustrated in FIG. 5. In such a case, it is preferable to control the height of the tip of the processing material 7 by changing the amount by which the drive stage 6 is raised in the Z direction.

At the time of processing of the second layer in region I, since the measurement result T1 of the first layer is equal to the target stacking height T0, the height of the tip of the processing material 7 of the processing material supply unit 10 need only be set to T0.

At the time of processing of the second layer in region II, the measurement result T2 of the first layer is higher than the target stacking height T0, so that, if the height of the tip of the processing material 7 is set to T0 from the upper surface of the workpiece 3, the height of the tip of the processing material 7 does not fall within the allowable range. Therefore, by setting the height of the tip of the processing material 7 to T2, the additive processing of the second layer can be performed without causing a processing defect.

At the time of processing of the second layer in region III, the measurement result T3 of the first layer is lower than the target stacking height T0, so that, if the height of the tip of the processing material 7 is set to T0 from the upper surface of the workpiece 3, the height of the tip of the processing material 7 does not fall within the allowable range. Therefore, by setting the height of the tip of the processing material 7 to T3, the additive processing of the second layer can be performed without causing a processing defect.

As described above, the occurrence of a processing defect can be prevented by adjusting the height of the tip of the processing material 7 on the basis of the measurement result of the height of the build object 4 that has been formed.

Moreover, the height of the tip of the processing material 7 is an example of the processing condition. The height of the tip of the processing material 7 is preferably controlled in accordance with the processing condition for changing the stacking height other than the height of the tip of the processing material 7, the processing condition being, for example, the feed speed of the processing material 7, the output of the processing laser 1, or the irradiation time of the processing light 30.

Moreover, as another example of the method of controlling the height of the tip of the processing material 7, before processing of an (n−1)-th layer, in a case where an average height of an (n−2)-th layer in regions I to III is higher than the target stacking height T0, an amount by which the height of the processing material supply unit 10 is to be raised after the processing of the (n−1)-th layer is completed may be set to an average height of the (n−2)-th layer, and optimal processing control may be performed using the measurement result of the (n−1)-th layer during the processing of the n-th layer.

As yet another example of the method of controlling the height of the tip of the processing material 7, in a case where the measurement result of the height of the build object 4 is different in each of the n-th layer in region I, the n-th layer in region II, and the n-th layer in region III as in FIG. 16, the amount by which the height of the tip of the processing material 7 is to be raised may be changed for each region.

As described above, by optimally controlling the processing condition using the measurement result of the stacking height of the (n−1)-th layer measured immediately before processing the n-th layer, the target stacking height can be always maintained at ha±α as illustrated in FIG. 5, and processing can be continued without causing a processing defect.

In FIGS. 15 and 16, the control is performed by changing the feed speed of the processing material 7 and the height of the tip of the processing material 7, but may be performed by changing another parameter or a plurality of parameters. For example, in a case where it is desired to reduce the stacking amount, it is possible to adapt a method of reducing the output of the processing laser 1 and increasing the stage speed to move the processing position.

Moreover, as illustrated in FIG. 8, in the case where the measurement position is set in the same direction as the direction in which the high temperature portion 32 is generated with respect to the processing position, when the n-th layer is stacked, the height of the n-th layer after stacking is measured. Therefore, in a case where the processing condition is controlled using the measured height of the processing material supply unit 10, it is sufficient if the measurement results of the height of the processing material supply unit 10 with respect to the measurement position are all saved for one layer and used when an (n+1)-th layer is stacked. Furthermore, the reference pixel position for measuring the height of the build object 4 is preferably set to the position of the target stacking height of the n-th layer instead of the position of the target stacking height of the (n−1)-th layer.

As described above, the additive manufacturing apparatus 100 of the present embodiment measures the bead height in the progressing direction of the stacking processing during processing and controls the processing condition to be appropriate at the time of the next processing, thereby being able to maintain the target stacking height.

Moreover, since the additive manufacturing apparatus 100 of the present embodiment can maintain the height between the supply port and the bead constant, the additive manufacturing apparatus 100 can prevent a decrease in the accuracy of forming the build object 4 and achieve highly accurate stacking processing.

The additive manufacturing apparatus 100 of the present embodiment has been described as the apparatus that is made compact by integrating the light receiving optical system with the processing head 2 in order to measure the bead height at a position close to the processing position. However, it is not necessary that the light receiving optical system and the processing head 2 are strictly integrated, and it goes without saying that a similar effect can be obtained even in a case where the light receiving optical system is disposed as a separate body from the processing head 2 to measure the height of the stacked object in the vicinity of the processing position 50.

Here, since the light receiving optical system according to the present embodiment measures the height using the line beams 41 and 42, the condenser lens 15 not used both for processing and for height measurement is preferably an optical system that can form an image of only the line beams 41 and 42 on the light receiver 16.

The present embodiment uses the drive stage 6 being a five-axis stage that can move in an oblique direction by simultaneously moving any two or all axes of the XYZ directions and can also rotate in the XY plane and the YZ plane, thereby being able to measure the height of the build object 4 even when shaping a shape other than a straight line.

Moreover, in the present embodiment, since the illumination light is emitted at an angle with respect to the vertical direction, the irradiation position of the line beams 41 and 42 from the processing position changes depending on the shape of the build object 4 and the rotation of the drive stage 6.

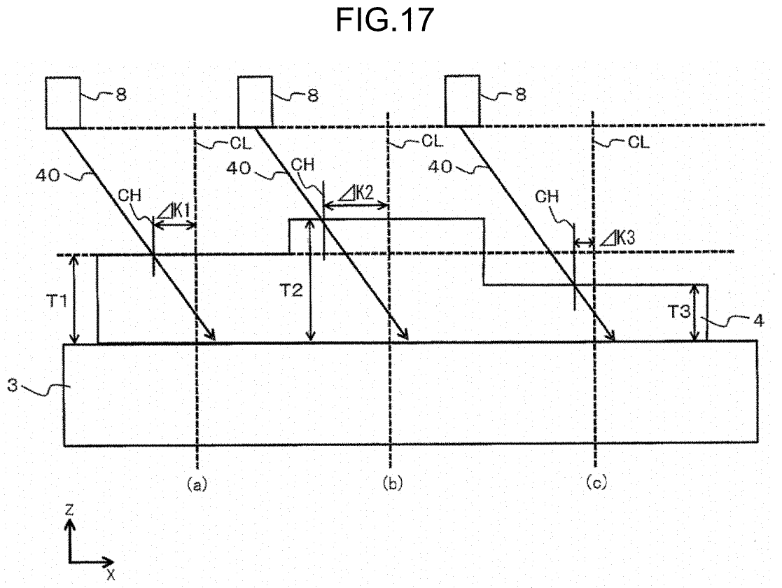

FIG. 17 is a diagram for explaining the irradiation position of the line beams 41 and 42 from the processing position with respect to the height of the build object 4. In FIG. 17, the processing material supply unit 10 is not illustrated for simplicity. In addition, for the sake of clarity, the central axes of the line beams 41 and 42 are represented as the central axis 40.

A portion (a) in FIG. 17 illustrates a case where a bead as designed is shaped when the target height of stacking is T1. At the time of stacking a second layer, the processing head 2 is raised by the same height as the bead height T1, so that when the drive stage 6 is moved to a position for measuring the processing position, the distance of a measurement position CH with respect to the optical axis CL of the processing light 30 is ΔK1.

A portion (b) in FIG. 17 illustrates a case where the stacking height T2 of the first layer is higher than the target stacking height T1. At the time of processing of a second layer, when the processing head 2 is raised by T1 and the drive stage 6 is moved to a position for measuring the processing position, the distance of the measurement position CH with respect to the optical axis CL of the processing light 30 is ΔK2>ΔK1.

A portion (c) in FIG. 17 illustrates a case where the stacking height T3 of the first layer is lower than the target stacking height T1. At the time of processing of a second layer, when the processing head 2 is raised by T1 and the drive stage 6 is moved to a position for measuring the processing position, the distance of the measurement position CH with respect to the optical axis CL of the processing light 30 is ΔK3<ΔK1.

As described above, the light cutting method of emitting the line beams 41 and 42 at an angle results in a shift of the measurement position when the height of the build object 4 that has been formed deviates from the target stacking height T1. The influence of the shift of the measurement position is small if the upper surface of the build object 4 is flat, but if the upper surface has a curved shape such as a complicated three-dimensional shape, the shift of the measurement position occurs.

However, the measurement position calculation unit 50 according to the present embodiment can calculate the measurement position for the processing position from the projection positions of the line beams 41 and 42 on the light receiving element.

Therefore, by calculating not only the height of the build object 4 but also the measurement position of the line beams 41 and 42 for the processing position and saving the measurement position and the measured height of the build object 4, the processing condition for the processing position can have higher accuracy.

Furthermore, the reference pixel position 60 is set as the focal point of the line beams 41 and 42, that is, the focal point of the light receiving optical system, but in a case where the shape of the build object is tilted with respect to the focal plane of the reference pixel position, the reference pixel position 60 varies from the target height of the build object 4.

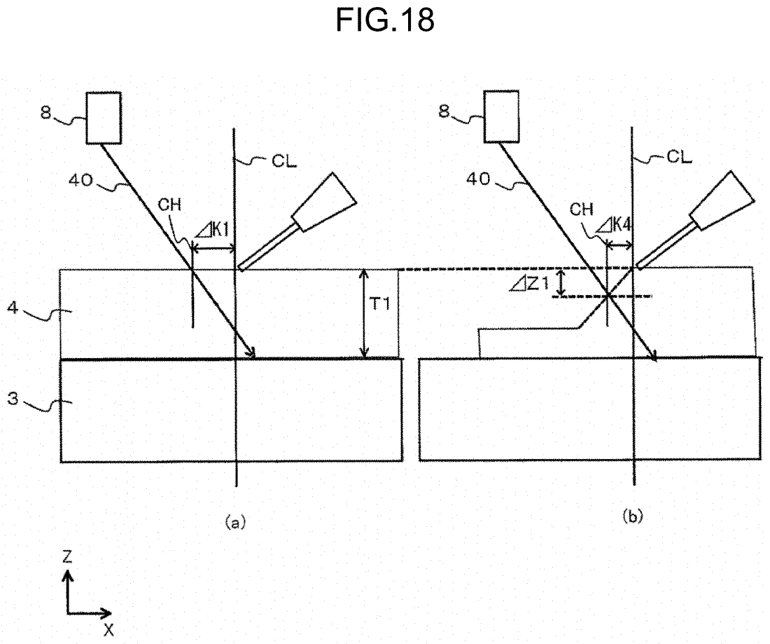

FIG. 18 is a diagram for explaining the reference pixel position and the target height with respect to the shape of the build object 4. In addition, for the sake of clarity, the central axes of the line beams 41 and 42 are represented as the central axis 40.

A portion (a) in FIG. 18 illustrates a case where a flat bead having the target stacking height T1 is shaped as designed. At the time of processing a second layer, the processing head 2 is raised by the same height as the height T1 of the bead, so that when the drive stage 6 is moved to a position for measuring the processing position, if the focal point of the line beams 41 and 42, that is, the focal point of the light receiving optical system is set as the reference pixel position 60, a difference from the target stacking height can be measured.

A portion (b) in FIG. 18 illustrates a case where the processing position is on a flat bead having the target height T1, but the measurement position is on the build object 4 inclined with respect to the shaping plane.

In the additive manufacturing apparatus 100, it is desirable to perform shaping by irradiating the workpiece 3 with the processing light 30 perpendicularly, and thus when an inclined shape as in the portion (b) in FIG. 18 is shaped, the surface subjected to shaping is inclined with respect to the processing light 30 by rotating the drive stage 6 so that the shaping is performed in a state where the processing light 30 is perpendicular to the surface subjected to shaping.

However, in the present embodiment, the measurement position for the processing position varies, so that it is conceivable to measure the height of the surface subjected to shaping that is inclined with respect to the processing surface as in the portion (b) in FIG. 18. In this case, when the height of the build object 4 is calculated with the focal point of the line beams 41 and 42, that is, the focal point of the light receiving optical system as the reference pixel position, the measurement is made to have a difference of ΔZ1 with respect to the target height. However, if the build object is shaped according to the target height when inclined, the shaping accuracy is reduced when the processing condition is controlled using the height ΔZ1 incorrectly measured.

However, since the calculation unit 51 of the present embodiment can determine whether the surface subjected to shaping, which is to be the measurement position, is inclined with respect to the processing surface from the future processing path, it is possible to calculate the target stacking height with respect to each measurement position for a freely selected shape.

Therefore, by correcting the result of the measured height using, for example, the amount of rotation of the build object by the drive stage 6, the measurement can be performed with higher accuracy.

In the present embodiment, the height of the build object 4 formed from the bead is measured, but a similar effect can be obtained even in the case of a ball bead.

As described above, in the present embodiment, the line beams 41 and 42 are continuously emitted from the measurement illumination unit 8 from the direction inclined with respect to the optical axis CL of the processing light 30 of the light receiving optical system to the angular range of ±90 degrees in the direction opposite the direction (+X direction) in which the processing material 7 is supplied, whereby the height of the build object 4 can be measured using a small apparatus even when the processing direction changes. Therefore, even in the case of shaping a complicated three-dimensional shape, the height of the build object 4 can be measured, so that the stacking processing can be performed with high accuracy. Moreover, instead of providing the line beam for each processing direction, the line beams 41 and 42 are provided so as to irradiate the angular range of ±90 degrees in the direction opposite the direction in which the processing material 7 is supplied, whereby it is only necessary to calculate the centroid position toward the direction in which the processing material 7 is supplied, which simplifies the height calculation processing.

### Second Embodiment

A difference between the first embodiment and a second embodiment is the shape of the line beams.

The line beams according to the present embodiment are the line beams 41 and 42 having an arc shape on the XY plane.

Note that hereinafter, only differences from the first embodiment will be described, and description of parts will be omitted. Regarding the reference numerals as well, the same or corresponding parts as those in the first and second embodiments will be denoted by the same reference numerals as those assigned to such parts in the first and second embodiments, and the description thereof will be omitted.

In the first embodiment, the line beams 41 and 42 having a linear shape are used, whereby the measurement position from the processing position changes depending on the processing direction as illustrated in FIG. 10.

In the present embodiment, the height of the build object at the same distance from the processing position is measured regardless of the processing direction, whereby the shape of line beams 412 and 422 is different from that of the first embodiment.

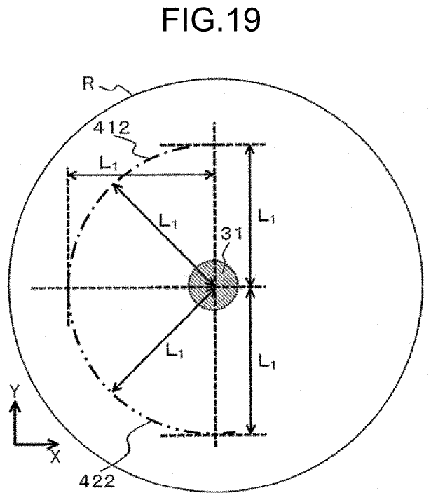

FIG. 19 is a diagram of the XY plane of the line beams 412 and 422 projected on the workpiece 3 that is flat by the measurement illumination unit 8 according to the present embodiment. As illustrated in FIG. 19, the present embodiment uses the line beams 412 and 422 having an arc shape on the XY plane. The installation position of the measurement illumination unit 8 and the inclination θ of the optical axis of the line beams with respect to the vertical direction in the XZ plane are similar to those in the first embodiment.

When the line beams 412 and 422 having the arc shape are used on the XY plane as described above, the projection positions of the line beams on the plane to be the reference pixel position are always at the distance L₁ from the processing position regardless of the processing direction.

In the first embodiment, the distance L₂ of the measurement position from the processing position in each of the 135 degree direction, which is the midpoint between the +Y direction and the −X direction, and the 225 degree direction, which is the midpoint between the −Y direction and the −X direction, where the measurement position is closest to the processing position is equal to W or more, and the distance L₁>L₂ from the measurement position on the build object 4 in the −X direction and the ±Y directions and the processing position is at the position farther away from the processing position.

On the other hand, in the present embodiment, the position closest to the processing position can be measured in all processing directions, so that when the irradiation angles of the line beams 41 and 42 are fixed, the installation position of the measurement illumination unit 8 can be brought close to the processing head 2, which enables further downsizing as compared to the first embodiment.

In addition, since the imaging area of the light receiver 16 where the line beams 41 and 42 enter is small, the resolution per pixel of the light receiver 16 can be increased, and the measurement accuracy can be improved.

### Third Embodiment

A difference between the first and second embodiments and a third embodiment is the positions in which the measurement illumination unit and the light receiving optical system are provided.

Note that hereinafter, only differences from the first and second embodiments will be described, and description of parts will be omitted. Regarding the reference numerals as well, the same or corresponding parts as those in the first and second embodiments will be denoted by the same reference numerals as those assigned to such parts in the first and second embodiments, and the description thereof will be omitted.

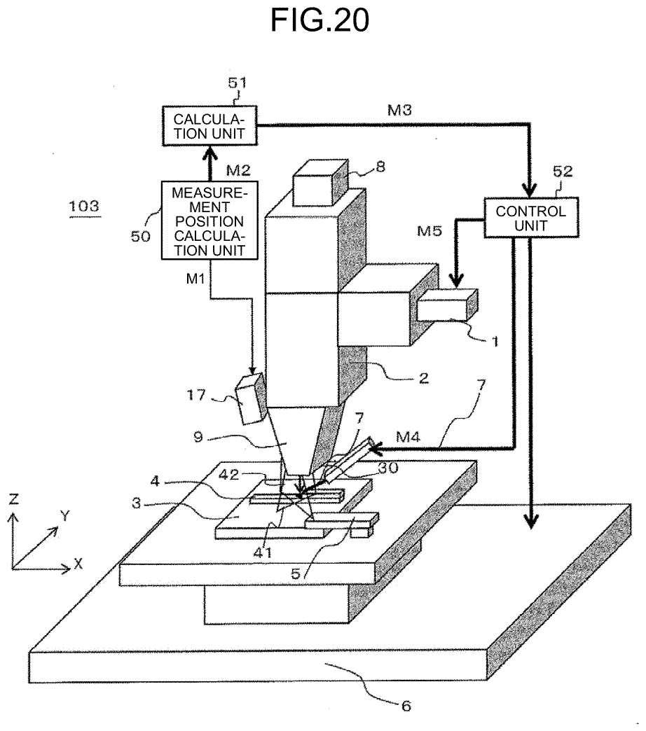

FIG. 20 is a view illustrating a configuration of an additive manufacturing apparatus 103 according to the present embodiment. In the additive manufacturing apparatus 103, the measurement illumination unit 8 is incorporated in the processing head 2, and the light receiving unit 17 including the light receiving optical system and the light receiving element is attached to a side surface of the processing head 2.

In the additive manufacturing apparatus 103, the measurement illumination unit 8 projects the line beams 41 and 42, which are the line beams 41 and 42, in parallel with the optical axis CL of the processing light 30. Moreover, the light receiving unit 17 receives the reflected light reflected in an oblique direction.

As a result, the measurement position of the line beams 41 and 42 does not shift, so that the height of the build object 4 can be measured with high accuracy.

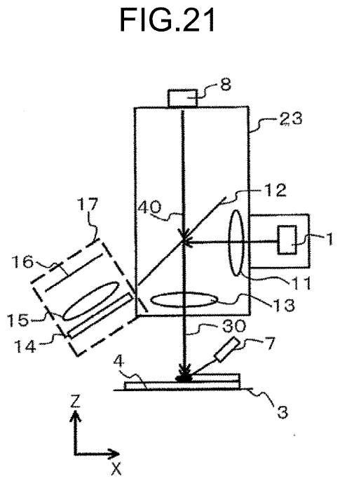

FIG. 21 is a diagram illustrating an internal configuration of the processing head 2 illustrated in FIG. 20. FIG. 21 illustrates a side view of the additive manufacturing apparatus 103. A processing head 23 includes the transmitter lens 11, the beam splitter 12, the objective lens 13, and the measurement illumination unit 8.

The line beams 41 and 42 output from the measurement illumination unit 8 are transmitted through the beam splitter 12 and emitted to the processing position on the build object 4, which is the measurement position, through the objective lens 13. In FIG. 21, for the sake of clarity, the central axes of the line beams 41 and 42 are represented as the central axis 40.

As the beams pass through the objective lens 13 for processing, the measurement illumination unit 8 emits the beams having a characteristic of being condensed on the build object 4 through the objective lens 13.

The light receiving unit 17 includes the condenser lens 15 and the light receiver 16. As in the present embodiment, the light receiving unit 17 preferably further includes the band pass filter 14 that selectively transmits the irradiation wavelengths of the line beams 41 and 42.

In the present embodiment, the measurement illumination unit 8 projects the line beams 41 and 42, which are the line beams 41 and 42, in parallel with the optical axis of the processing light 30, and the light receiving unit 17 receives the reflected light reflected in the oblique direction, so that the height of the build object 4 can be measured without being affected by the shift of the measurement position due to the height of the build object 4 illustrated in FIG. 17. Therefore, even when a complicated three-dimensional shape is measured, the height of the build object that is always at a constant distance with respect to the processing position can be measured, so that the processing condition can be controlled with high accuracy, and the shaping accuracy can be improved.

Also in FIG. 21, the example of the configuration in which the measurement illumination unit 8 is integrated with the processing head 23 is described, but the present embodiment is not limited to such an example. For example, the measurement illumination unit 8 and the processing head 2 may be separate bodies. In this case, it is sufficient if the optical axes of the line beams 41 and 42 emitted from the measurement illumination unit 8 and the optical axis of the processing light 30 are parallel to each other, and the measurement position that is at a predetermined distance from the processing position is irradiated with the line beams. Furthermore, it goes without saying that a similar effect can be obtained as long as the light receiving unit 17 is configured to receive the reflected light reflected in the oblique direction.

The configuration illustrated in the above embodiment merely illustrates an example of the content of the present invention, and can thus be combined with another known technique or partially omitted and/or modified without departing from the scope of the present invention.

### REFERENCE SIGNS LIST

1 processing laser; 2, 23 processing head; 3 workpiece; 4 build object; 41, 42 line beam; 5 fixture; 6 drive stage; 7 processing material; 8 measurement illumination unit; 9 gas nozzle; 10 processing material supply unit; 50 measurement position calculation unit; 51 calculation unit; 52 control unit.

1. An additive manufacturing apparatus comprising:
height measurement circuitry to measure a height at a measurement position of a build object formed on a workpiece and output a measurement result indicating a result of the measurement during additive processing in which the build object is formed by repeatedly stacking a processing material that is melted at a processing position on a surface of the workpiece; and
control circuitry to control a processing condition in performing new stacking at the measurement position in accordance with the measurement result, wherein
the height measurement circuitry includes:
a measurement illumination system to irradiate the measurement position with illumination light for measurement; a light receiving optical system to receive, by a light receiving element, reflected light obtained by reflection of the illumination light for measurement at the measurement position; and calculation circuitry to calculate the height of the build object formed on the workpiece on the basis of a light receiving position of the reflected light on the light receiving element,
an optical axis of the illumination light for measurement is inclined with respect to an optical axis of the light receiving optical system, and
the illumination light for measurement is emitted over an angular range of at least ±90 degrees with reference to a direction opposite a direction of supply of the processing material with the optical axis of the light receiving optical system as a center of a rotational angle range.

2. The additive manufacturing apparatus according to claim 1, wherein
the measurement position is a position at which the processing material is solidified, the position being moved with a movement of the processing position.

3. The additive manufacturing apparatus according to claim 1, wherein
the measurement position is within a field of view of the light receiving element.

4. The additive manufacturing apparatus according to claim 1, wherein
the measurement position is located in a direction of movement of the processing position on the workpiece as viewed from the processing position.

5. The additive manufacturing apparatus according to claim 1, wherein
the measurement illumination system projects an arc-shaped line beam.

6. The additive manufacturing apparatus according to claim 1, comprising
a processing optical system to image processing light that melts the processing material at the processing position.

7. The additive manufacturing apparatus according to claim 6, wherein
the light receiving optical system is provided integrally with the processing optical system.

8. The additive manufacturing apparatus according to claim 6, wherein
the measurement illumination system is provided integrally with the processing optical system.

9. The additive manufacturing apparatus according to claim 1, wherein
the height measurement circuitry includes measurement position calculation circuitry to calculate a future processing direction with respect to the measurement position.

10. The additive manufacturing apparatus according to claim 1, wherein
the control circuitry reduces an amount of supply of the processing material to be supplied to the processing position when the measurement result is higher than a target value that is a preset height of a stacked object, or increases the amount of supply when the measurement result is lower than the target value.

11. The additive manufacturing apparatus according to claim 6, wherein
the control circuitry reduces an output of the processing light when the measurement result is higher than a target value that is a preset height of a stacked object, or increases the output of the processing light when the measurement result is lower than the target value.

12. The additive manufacturing apparatus according to claim 1, wherein
the control circuitry increases a speed of moving the processing position when the measurement result is higher than a target value that is a preset height of a stacked object, or decreases the speed of moving the processing position when the measurement result is lower than the target value.

13. The additive manufacturing apparatus according to claim 1, wherein
the control circuitry raises a height of a tip of the processing material in accordance with a target value that is a preset height of a stacked object, and increases an amount by which the height of the tip of the processing material is raised when the measurement result is higher than the target value or decreases the amount by which the height of the tip of the processing material is raised when the measurement result is lower than the target value.
